(19) United States
(12) Patent Application Publication
(10) Pub. No.: US 2012/0221423 A1
(43) Pub. Date: Aug. 30, 2012

(54) COMMODITY CARRIER

(75) Inventor: Ryu Morita, Izunokuni-shi (JP)

(73) Assignee: TOSHIBA TEC KABUSHIKI KAISHA, Tokyo (JP)

(21) Appl. No.: 13/372,608

(22) Filed: Feb. 14, 2012

(30) Foreign Application Priority Data
Feb. 25, 2011 (JP) 2011-039915

(51) Int. Cl. G06Q 30/06; G06Q 20/20

(52) U.S. Cl. 705/23; 705/16; 705/24

(57) ABSTRACT

According to one embodiment, a commodity carrier includes a container, an acquisition unit, a determination unit, a first display, a second display and a control unit. The container holds one or more commodities. The acquisition unit acquires an identification information of each of the one or more commodities held in the container. The determination unit determines completion of the settlement about all commodity identified by the one or more identification information acquired by the acquisition unit. The first display displays a notice information for the customer purchasing the one or more commodities held in the container. The second display enables to see in a range wider than a visual range within which the information displayed on the first display is recognized. The control unit controls the second display to display whether or not the determination in which the settlement is completed is performed by the determination unit.

### CROSS-REFERENCE TO RELATED APPLICATION

This application is based upon and claims the benefit of priority from Japanese Patent Application No. 2011-039915, filed Feb. 25, 2011, the entire contents of which are incorporated herein by reference.

### FIELD

Embodiments described herein relate generally to a commodity carrier.

### BACKGROUND

Typically, commodity carriers such as shopping cart are used in a supermarket to carry commodities. And generally, commodities which are settled or unsettled are carried with the same commodity carrier.

### BRIEF DESCRIPTION OF THE DRAWINGS

FIG. 1 is a block diagram of the electrical devices arranged in a shopping cart;

FIG. 2 is a perspective view showing the appearance of a shopping cart;

FIG. 3 is a diagram illustrating an example of a commodity list stored in a commodity list area;

FIG. 4 is a flow chart of the processing carried out by a CPU;

FIG. 5 is a diagram illustrating an example of a display screen; and

FIG. 6 is a flow chart of the processing carried out by a CPU.

### DETAILED DESCRIPTION

According to one embodiment, it is to provide a commodity carrier comprising a container, an acquisition unit, a determination unit, a first display, a second display and a control unit. The container configured to hold one or more commodities. The acquisition unit configured to acquire an identification information of each of the one or more commodities held in the container. The determination unit configured to determine completion of the settlement about all commodities identified with the one or more identification information acquired by the acquisition unit. The first display configured to display notice information for the customer purchasing the one or more commodities held in the container. The second display configured to enable to see in a range wider than a visual range within which the information displayed on the first display is recognized. The control unit configured to control the second display so as to display whether or not the determination in which the settlement is completed is performed by the determination unit.

An example of the embodiment is described below with reference to accompanying drawings. Besides, in this embodiment, description is made by referring a shopping cart as an example of the commodity carrier.

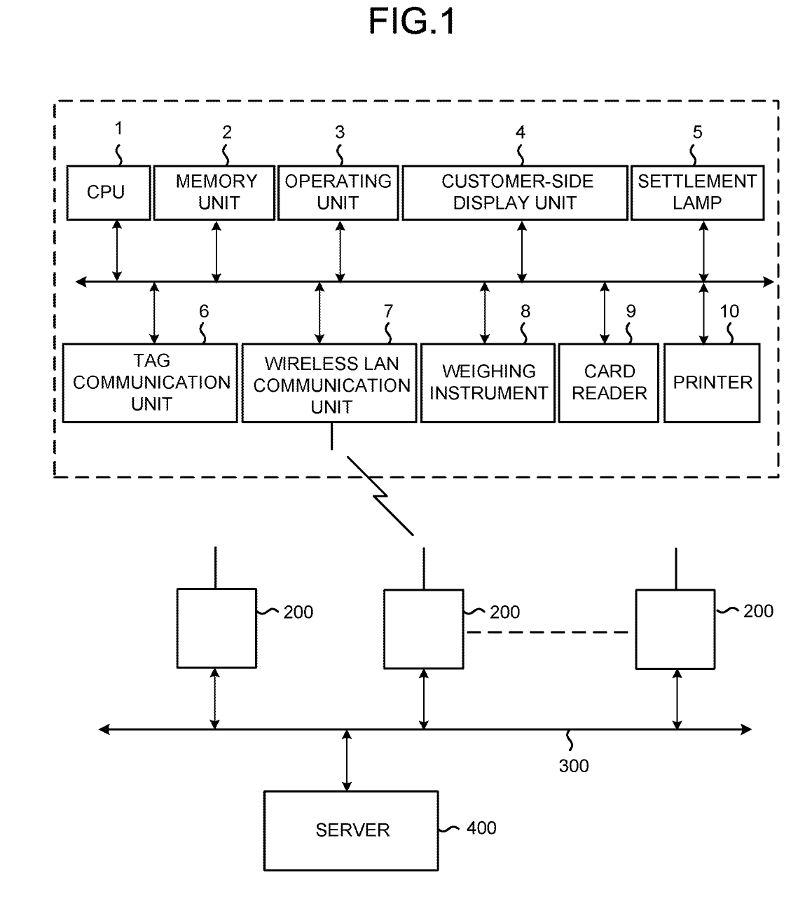

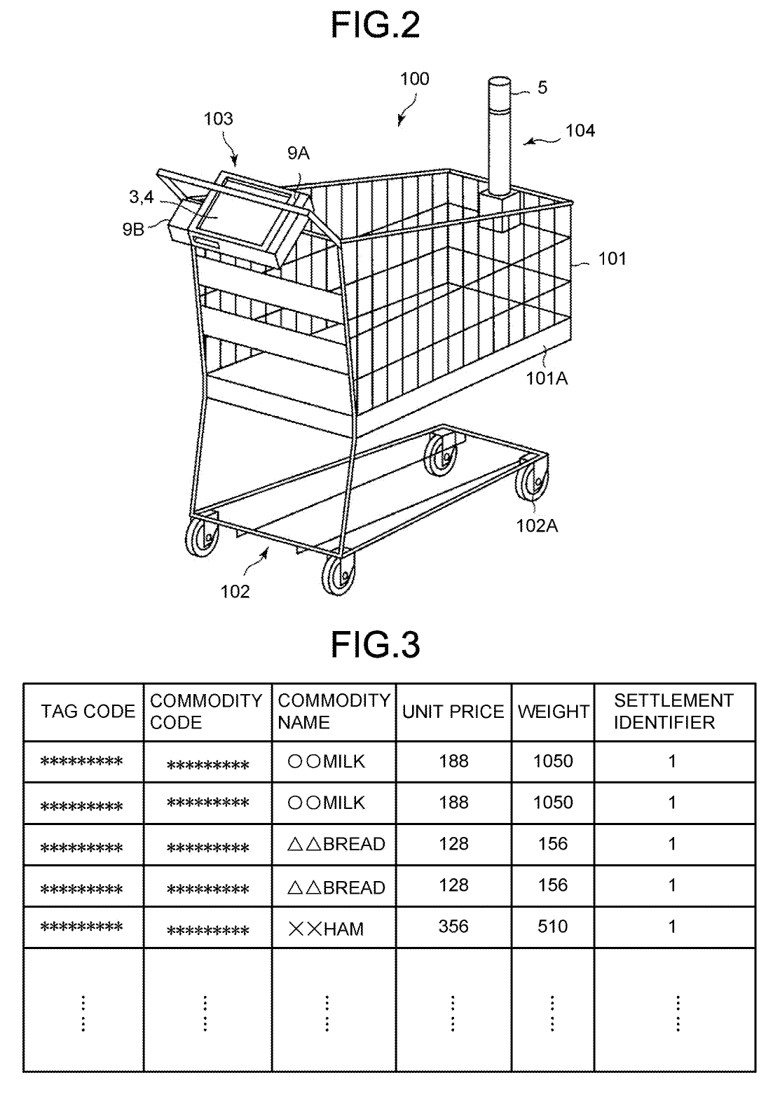

FIG. 1 is a block diagram of the electrical devices arranged in a shopping cart 100 according to this embodiment. FIG. 2 is a perspective view showing the appearance of the shopping cart 100.

As shown in FIG. 1, the shopping cart 100 includes, as electrical devices, a central processing unit (CPU) 1, a memory unit 2, an operating unit 3, a customer-side display device 4, a settlement lamp 5, a tag communication unit 6, a wireless local area network (LAN) communication unit 7, a weighing unit 8, a card reader 9 and a printer 10. The CPU 1, the memory unit 2, the operating unit 3, the customer-side display device 4, the settlement lamp 5, the tag communication unit 6, the wireless LAN communication unit 7, the weighing unit 8, the card reader 9 and the printer are connected with a bus line 11. Besides, the customer-side display device 4, the settlement lamp 5, the tag communication unit 6, the wireless LAN communication unit 7, the weighing unit 8, the card reader 9 and the printer 10 may also be connected with the bus line 11 via a controller and a communication cable. These electrical devices operate with power supplied by a battery (not shown)

As shown in FIG. 2, the shopping cart 100 comprises a shopping basket 101, a moving mechanism 102, a user interface unit 103 and a lamp unit 104.

The CPU 1 operates according to the operating system (OS), the middleware and the applications stored in the memory unit 2 to control the memory unit 2, the operating unit 3, the customer-side display device 4, the settlement lamp 5, the tag communication unit 6, the wireless LAN communication unit 7, the weighing unit 8, the card reader 9 and the printer 10.

The memory unit 2 comprises a read-only memory (ROM) and a random-access memory (RAM). The memory unit 2 may further comprise an auxiliary memory unit such as hard disk drive (HDD) or solid state drive (SSD). The memory unit 2 stores the above-mentioned operating system, middleware and applications. The memory unit 2 may store data for the CPU 1 to refer to in executing various processing as well. The memory unit 2 serves as a working area for storing data temporarily used by the CPU 1 in executing various processing. Part of the memory area of the memory unit 2 serves as a commodity list area.

FIG. 3 is a diagram illustrating an example of a commodity list stored in the commodity list area.

As shown in FIG. 3, in the commodity list area, a plurality of data areas (data fields) which store a tag code, a commodity code, a commodity name, a unit price, a weight and a settlement flag in a correlated manner are provided respectively. In this way, a commodity name, a unit price, a weight and a settlement flag can be stored in the commodity list area corresponding to commodity identification information comprising combination of the tag code and the commodity code.

In addition, in FIG. 3, tag codes and commodity codes are not shown in detail.

Typically, the operating unit 3 is a touch sensor, and in this case, the operating unit is laminated on the display panel of the customer-side display device 4 and outputs, when the display screen of the customer-side display device 4 is touched, a detection signal in response to the touched position.

The customer-side display device 4, which is typically a liquid crystal display (LCD), displays images under the control of the CPU 1. And generally, the image displayed by the customer-side display device 4 is an image showing the information that should be shown to the customer using the shopping cart 100 (hereinafter referred to as customer).

Under the control of the CPU 1, the settlement lamp 5 can selectively take at least two display states, which may be, for example, an ‘on’ state and an ‘off’ state, or two ‘on’ states in which the lamp gives out lights of different colors (e.g. red and blue). The display state of the settlement lamp 5 can be widely seen by other people (excluding the customer using the shopping cart) around the shopping cart 100. And it is desired that the display state of the settlement lamp 5 can be recognized at any long-distance position in a 360-degree horizontal range. The display state recognition range of the settlement lamp 5 should be at least wider than that of the customer-side display device 4.

The tag communication unit 6 communicates with a radio frequency identification (RFID) tag adhered on a commodity to acquire at least the identification code of the RFID tag (hereinafter referred to as tag code) and a commodity identification code (hereinafter referred to as commodity code). The tag communication unit 6 takes a communication range within the shopping basket 101.

The wireless LAN communication unit 7 communicates with a server 400 via one of a plurality of wireless access points 200 and an LAN 300. The wireless access points 200 are set at different positions in a shop. The server 400, which is a so-called shop server equipped in a shop or a so-called main server equipped in the headquarter which manages a plurality of shops. The server 400 calculates the sum of commodity sales data or manages data used in the shopping carts 100. The server 400 maintains a price lock up (PLU) file relating to the commodities sold in the shop. The PLU file includes various information, containing a commodity name, a unit price and a weight, which is correlated with the commodity codes of the commodities sold in the shop. Moreover, the server 400 stores a sales file in which the sales of each commodity sold in the shop is recorded in correlation with each commodity code.

The weighing unit 8 weighs the total weight of the commodities in the shopping basket 101.

The card reader 9 reads out card information recorded in a settlement card, which is used to settle without cash and may be a credit card, an electronic integrated circuit (IC) card, a debit card and a prepaid card.

The printer 10 may be a thermal printer or an impact dot printer for printing a transaction certification (receipt).

The shopping basket 101, the inside of which is a commodity-holding space, has a case 101a formed in a box shape at the bottom thereof for installing the CPU 1, the memory unit 2, the tag communication unit 6, the wireless LAN communication unit 7 and the weighing unit 8. The shopping basket 101 supplies support for the user interface unit 103 and the lamp unit 104.

The moving mechanism 102, which is located below the shopping basket 101 to support the shopping basket 101, has four wheels 102a and is movable under the hand-push of the customer.

The operating unit 3, the customer-side display device 4, the card reader 9 and the printer 10 are accommodated in the user interface unit 103 which orients the customer-side display device 4 toward the customer. In this embodiment, the card reader 9 responds to a credit card having a magnetic strip and a non-contact type electronic IC card (so-called electronic money card). The card reader 9 reads out card information from a credit card swept by the customer along a card slot 9a. The card reader 9 also wirelessly reads out card information from an IC card which gains access to a reading unit 9b. Further, the card reader 9 may also read, from IC chips mounted on mediums other than IC card, information similar to card information. The printer 10 discharges a printed transaction certification from an outlet 10a to the outside of the user interface unit 103.

The lamp unit 104 comprises a settlement lamp 5 and enables the settlement lamp 5 in an ‘on’ state to be easily recognized by the people around the customer.

The actions of the above-mentioned shopping cart 100 will be described below.

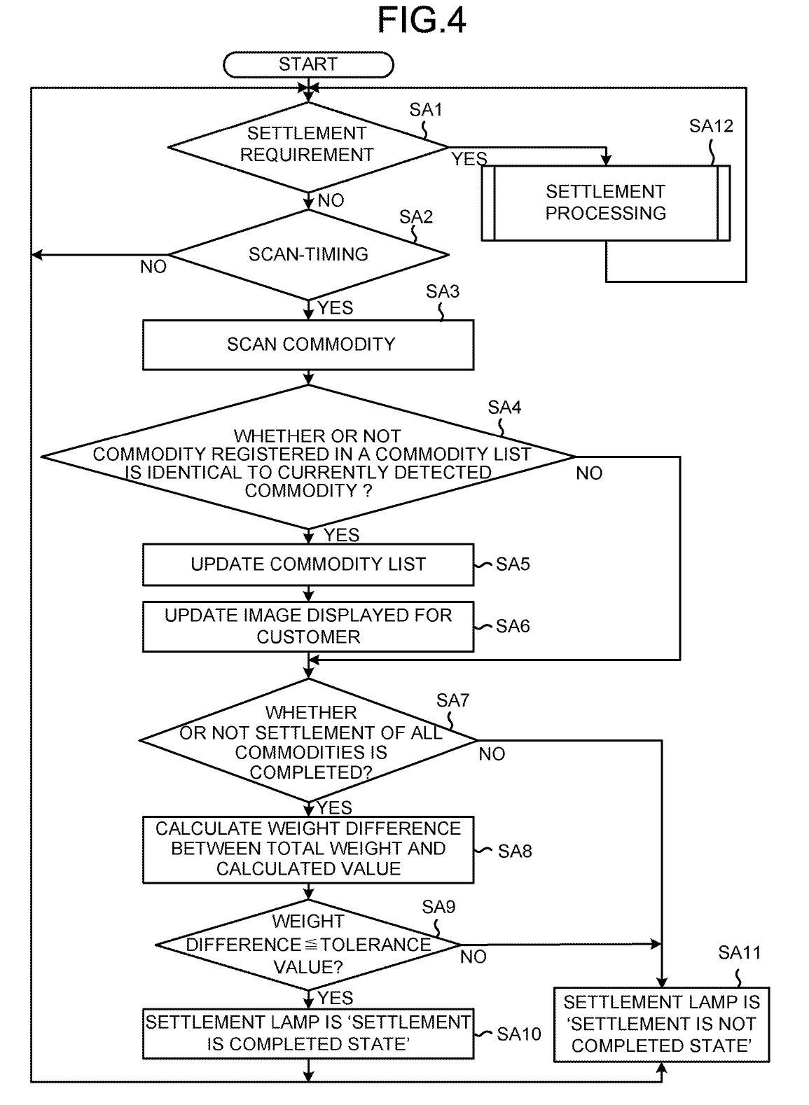

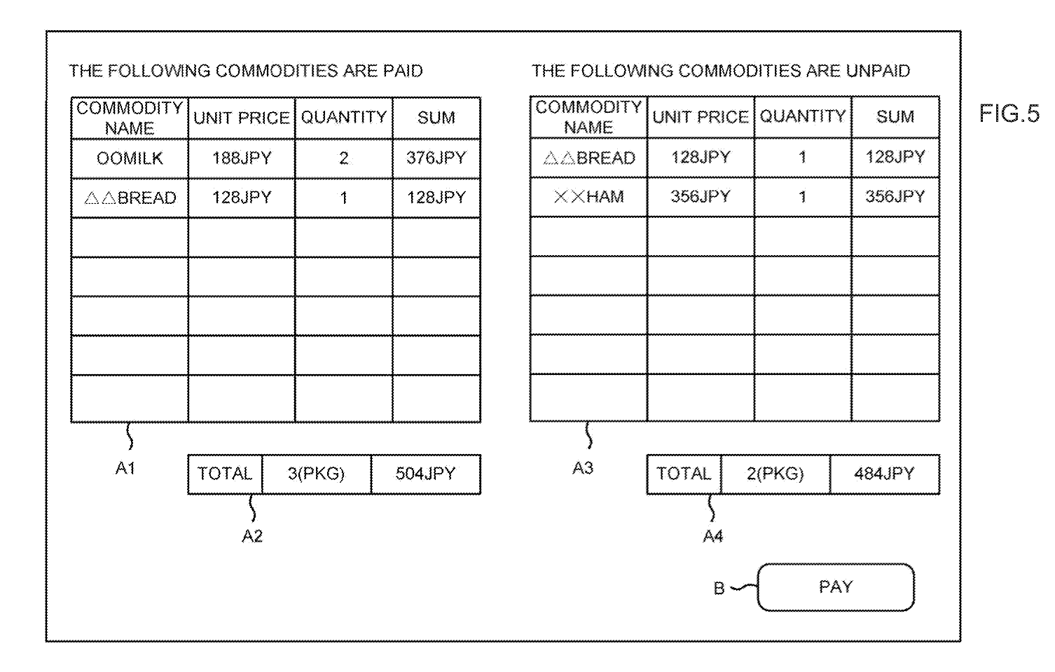

The processing shown in FIG. 4 starts when the CPU 1 is activated.

In Acts Sa1 and Sa2, the CPU 1 in a standby state repeatedly judges whether or not settlement is requested and whether or not a scanning timing comes. And the CPU 1 proceeds to Act Sa3 from Act Sa2 when the scanning timing comes. In addition, the scanning timing is set to be, for example, a certain time interval (several seconds)

In Act Sa3, the CPU 1 scans commodities held in the shopping basket 101. Specifically, the CPU 1 instructs the tag communication unit 6 to acquire information from the RFID tags adhered on the commodities held in the shopping basket 101, and thus the CPU 1 captures information acquired by the communication unit 6 from the RFID tags according to the instruction.

In Act Sa4, the CPU 1 judges whether or not the commodity registered in a commodity list is identical to the currently detected commodity by comparing the information captured in Act Sa3 with the information recorded in a commodity list area. If the commodity registered in the commodity list is different from the currently detected commodity, the CPU 1 proceeds to Act Sa5 from Act Sa4, otherwise, the flow directly turns to Act Sa7, skipping Acts Sa5 and Sa6 described later.

In Act Sa5, the CPU 1 updates the commodity list. Specifically, the CPU 1 adds the tag code and the commodity code relating to the currently detected commodity to the commodity list area. The CPU 1 acquires information such as commodity name, unit price and weight from the server 400 according to the commodity code, writes the acquired information in the commodity list area after correlating the acquired information with the tag code and the commodity code and sets a settlement flag to be ‘0’ at the same time. In addition, the CPU 1 may acquire a PLU file from the server 400 and store the acquired PLU file in the memory unit 2 beforehand, and then read out information such as commodity name, unit price and weight from the memory unit 2. Further, the information relating to the commodity that is registered in the commodity list but is not detected currently is deleted from the commodity list area.

In Act Sa6, the CPU 1 changes the display screen on the customer-side display device 4 to display the updated content of the commodity list.

FIG. 5 is a diagram illustrating an example of a display screen on the customer-side display device 4. FIG. 5 shows an example of a display screen when the commodity list is in the state shown in FIG. 3.

The display screen shown in FIG. 5 includes display areas A1, A2, A3 and A4 and a button B.

Commodity names, unit prices, quantities and sums of the paid money of the commodities settled by the settlement processing described later are shown in the display area A1. The CPU 1 displays, in the display area A1, the information correlated with the settlement flags whose state is ‘1’ in the commodity list.

The total quantity and the total of sums of the paid money of commodities settled are shown in the display area A2.

Commodity names, unit prices, quantities and sums of the payable money of the commodities unsettled are shown in the display area A3. The CPU 1 displays, in the display area A3, the information correlated with the settlement flags whose state is ‘0’ in the commodity list.

The total quantity and the total of sums of the payable commodities unsettled are shown in the display area A4.

The button B is for the customer to require a settlement.

The settlement processing is described below.

If the customer touches the button B when the CPU 1 is in the standby state described in Acts Sa1 and Sa2, then the CPU 1 determines there is a settlement requirement (Act Sa1:YES) and then proceeds to Act Sa12 directly from Act Sa1 to execute a settlement processing.

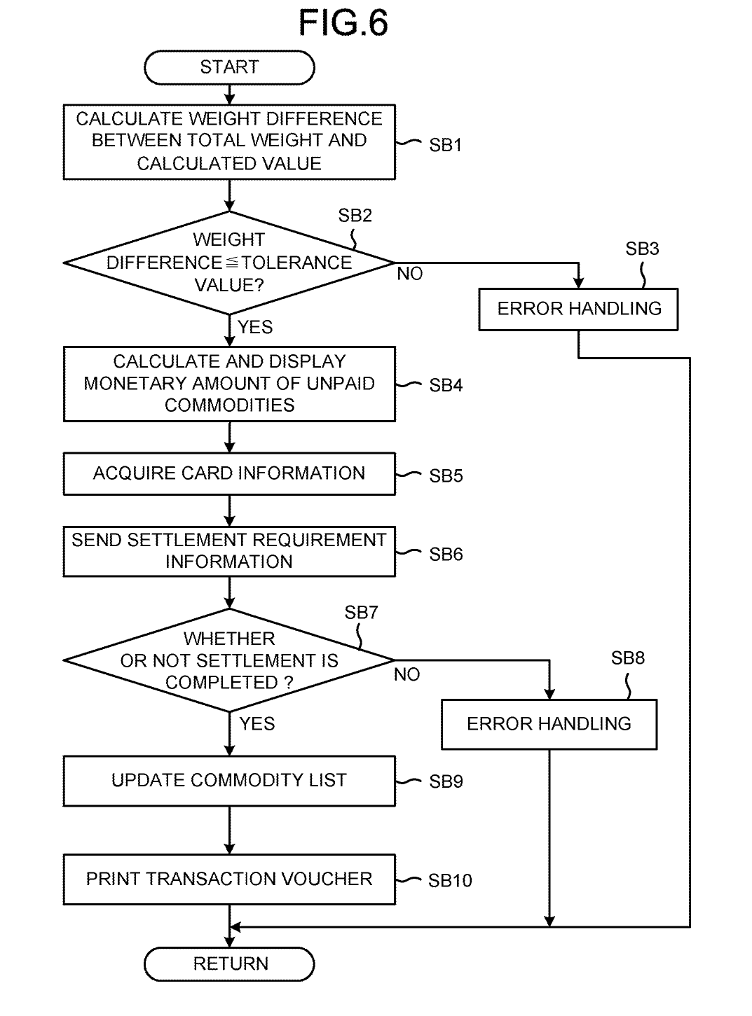

FIG. 6 is a flow chart of a settlement processing.

In Act Sb1, the CPU 1 calculates the weight difference between the total weight calculated as the sum of the weights stored in the commodity list area and the weight measured by the weighing unit 8.

In Act Sb2, the CPU 1 judges whether or not the weight difference is below a predetermined tolerance value. If the weight difference is above the tolerance value, the CPU 1 proceeds to Act Sb3 from the Act Sb2 to perform an error handling, which refers to, for example, a process of notifying the customer that the commodities placed in the shopping basket 101 cannot be scanned correctly, and then ends the settlement processing after the error handling is completed.

If the weight difference is below the tolerance value, the CPU 1 proceeds to Act Sb4 from Act Sb2.

In Act Sb4, the CPU 1 calculates the monetary amount of the unsettled commodities in the shopping basket 101. Specifically, the CPU 1 summates the unit prices correlated with the settlement flag ‘0’ in the commodity list and displays the calculated sum on the customer-side display device 4.

After confirming the monetary amount displayed on the customer-side display device 4, the customer sweeps a credit card along the card slot 9a or holds an IC card to the reading unit 9b so that the card reader 9 can read card information from the credit card or the IC card.

In Act Sb5, the CPU 1 acquires the card information read by the card reader 9.

In Act Sb6, the CPU 1 sends the server 400 a settlement requirement including the monetary amount calculated in Act Sb4 and the card information acquired in Act Sb5.

In addition, in the server 400, once there is a need to perform a management on the actual sales of commodities and the like, the CPU 1 sends the server 400 requirement information for registration regarding the unsettled commodities among the commodities in the shopping basket 101. The registration requirement information contains at least commodity code and may further contain other various information such as a tag code, a quantity, a detection date/time and the like. The registration requirement information may be contained in or different from the settlement requirement information. The server 400 updates, for example, a sales file, according to the received registration requirement information.

The server 400 executes a well-known processing to settle the monetary amount after receiving the settlement requirement information, and sends the shopping cart 100 a response indicating whether or not the settlement is completed. The wireless LAN communication unit 7 receives the response and forwards the response to the CPU 1.

In Act Sb7, the CPU 1 judges whether or not the settlement is completed according to the response. If the settlement is uncompleted, the CPU 1 proceeds to Act Sb8 from the Act Sb7 to execute an error handling, which refers to a process of notifying the customer of the failed settlement, and then ends the settlement processing after the error handling is completed.

The CPU 1 proceeds to Act Sb9 from Act Sb7 if the settlement is completed.

In Act Sa9, the CPU 1 updates the commodity list. Specifically, the CPU 1 changes all the settlement flags, whose state is ‘0’, correlated with the commodity codes in the commodity list to ‘1’.

In Act Sb10, the CPU 1 instructs the printer 10 to print a transaction certification for the commodities currently settled. The printer 10 prints a transaction certification according to the instruction, and then the CPU 1 ends the settlement processing.

After ending the settlement processing, the CPU 1 returns to be in the standby state in Acts Sa1 and Sa2 shown in FIG. 4.

As stated above, the settlement flags of commodities settled is ‘1’. The CPU 1 judges, in the Act Sa7 in FIG. 4, whether or not the commodities in the shopping basket 101 are settled by judging whether or not the settlement flags of all the commodities registered in the commodity list are changed to ‘1’. The CPU 1 proceeds to Act Sa8 from Act Sa7 after determining the commodities in the shopping basket 101 are settled.

In Act Sa8, the CPU 1 calculates the weight difference between a total weight calculated as the sum of the weights stored in the commodity list area and the weight measured by the weighing unit 8.

In Act Sa9, the CPU 1 judges whether or not the weight difference is below a predetermined tolerance value. If the weight difference is below the tolerance value, the CPU 1 sequentially proceeds to Act Sa10. In Act Sa10, the CPU 1 sets the state of the settlement lamp 5a to ‘settled’ state, which refers to, for example, the ‘on’ state of the settlement lamp or an ‘on’ state in which the settlement lamp gives off blue light.

On the other hand, the CPU 1 proceeds to Act Sa11 from Act Sa7 in the case where some of the commodities are unsettled or proceeds to Act Sa11 from Act Sa9 in the case where the weight difference is above the tolerance value. Moreover, in Act Sa11, the CPU 1 sets the state of the settlement lamp 5 to ‘unsettled’ state, which refers to, for example, the ‘off’ state of the settlement lamp or an ‘on’ state in which the settlement lamp gives off red light.

After completing Act Sa10 or Sa11, the CPU 1 returns to be in the standby state shown in the Acts Sa1 and Sa2.

As stated above, in the shopping cart 100, if the wireless LAN communication unit 7 can communicate with any of a plurality of wireless access points 200, then the commodities in the shopping basket 101 can be settled at any location in the shop, which greatly shortens settlement time for the customer, compared with the case where commodities can only be settled at a checkout counter. Moreover, the shop clarks nearby the shopping cart 100 can easily recognize whether or not the commodities in the shopping basket 100 are settled according to the state of the settlement lamp 5. Therefore, the shop clark only needs to prevent the customer from carrying a shopping cart 100 of the unsettled state in which the unsettled commodities are held out of the shop or moving the unsettled commodities in a shopping cart 100 into a bag, and additionally, the load of the shop clark who checks inadequate actions is reduced.

Moreover, in shopping cart 100, as the commodities placed in the shopping basket 101 are detected using RFID, there may be a possibility that some commodities in the shopping basket 101 are missed in a detection or commodities displayed outside the shopping basket 101 are incorrectly detected. However, in the shopping cart 100, the weight difference between the total weight of the detected commodities prerecorded in a FLU file and the one measured by the weighing unit is monitored. No settlement is performed if the weight difference is above the tolerance value, thus eliminating settlement in error caused by a commodity-missed detection or error detection. Moreover, as the settlement lamp 5 is not set to a settlement state when the weight difference is above the tolerance value even the settlement flags of the commodities registered in the commodity list are all changed to ‘1’, no ‘settled’ state is displayed if there is a commodity-missed detection or error detection. As a result, a high-accuracy commodity detection can be performed without any detection failed or incorrect detection, and repeated weight detection can be avoided.

This embodiment can have various variations.

The above-described implementation mode is also applicable to other commodity carriers different from the shopping cart 100, such as hand-carry shopping basket.

The settlement can also be performed with a settlement terminal at a checkout counter, as being similar to a conventional manner, different from the shopping cart 100. In this case, the CPU 1 notifies the settlement terminal of the tag codes and the commodity codes relating to the unsettled commodities contained in a commodity list. After a settlement is performed according to the tag codes and the commodity codes notified by the CPU 1, the settlement terminal notifies the CPU 1 of the tag codes and the commodity codes of the settled commodities. Upon receiving the notice, the CPU 1 changes the settlement flags relating to the matched commodities to be ‘1’. In this way, the commodities in the shopping basket 101 can be settled without commodities being taken out of the shopping basket 101, and whether or not the commodities in the shopping basket 101 are settled can be easily determined according to the state of the settlement lamp 5. Thus, it can be effectively prevented that unsettled commodities are inadequately taken out of the shop as settled commodities. In addition, some or all of the weighting unit 8, the card reader 9 and the printer 10 can be omitted from the shopping cart 100.

The commodity identification information can be acquired by reading the barcode attached to a commodity with a barcode scanner or inputting the commodity selection by the customer on a commodity selection screen displayed on the customer-side display device 4 through the operating unit 3, or by using other methods.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A commodity carrier, comprising:
a container configured to hold one or more commodities;
an acquisition unit configured to acquire an identification information of each of the one or more commodities held in the container;
a determination unit configured to determine completion of the settlement about all commodities identified with the one or more identification information acquired by the acquisition unit;
a first display configured to display a notice information for the customer purchasing the one or more commodities held in the container;
a second display configured to enable to see in a range wider than a visual range which enable to see the information displayed on the first display; and
a control unit configured to control the second display so as to display whether or not the determination in which the settlement is completed is performed by the determination unit.

2. The commodity carrier according to claim 1, further comprising an input unit configured to input the information for the settlement.

3. The commodity carrier according to claim 1, further comprising a printer and a unit configured to control the printer to print a certification relating to the settlement according to the determination in which completion of the settlement is performed by the determination unit.

4. The commodity carrier according to claim 1, further comprising:
a weighing unit configured to weigh the total weight of the one or more commodities held in the container;
a calculation unit configured to calculate the estimated total weight of all the commodities identified with the one or more pieces of the identification information acquired by the acquisition unit, wherein
the control unit controls the second display to display the determination in which completion of the settlement is not determined by the determination unit if the difference between the total weight measured by the weighing unit and the estimated total weight calculated by the calculation unit exceeds a predetermined value.

5. The commodity carrier according to claim 1, wherein the first display is able to display the names, the quantities and the prices of the commodities identified with the one or more pieces of identification information acquired by the acquisition unit and the second display only shows whether or not the determination in which the settlement is completed is performed by the determination unit.

6. A commodity carrier, comprising:
a container configured to hold one or more commodities;
an acquisition unit configured to acquire an identification information of each of the one or more commodities held in the container;
an input unit configured to input a settlement information for the settlement about all commodity identified by the one or more identification information acquired by the acquisition unit;
a sending unit configured to send the one or more identification information acquired by the acquisition unit and the settlement information input by the input unit to a settlement device;
a receiving unit configured to receive the result information which is sent by the settlement device to notify a settlement result;
a determination unit configured to determine completion of the settlement according to the result information received by the receiving unit;
a first display configured to display a notice information for the customer purchasing the one or more commodities held in the container;
a second display configured to enable to see in a range wider than a visual range within which the information displayed on the first display is recognized; and
a control unit configured to control the second display so as to display whether or not the determination in which the settlement is completed is performed by the determination unit;
a printer; and
a unit configured to control the printer to print a certification relating to the settlement according to the determination in which the settlement is completed is performed by the determination unit.
